(19) United States
(12) Patent Application Publication
(10) Pub. No.: US 2008/0008557 A1
(43) Pub. Date: Jan. 10, 2008

(54) THREADED FASTENER MEMBERS FORMED FROM SPIRAL WOUND WIRE

(75) Inventors: Henry R. Bucciero, Harper Woods, MI (US); Matthew Bucciero, Harper Woods, MI (US)

Correspondence Address: GIFFORD, KRASS, SPRINKLE,ANDERSON & CITKOWSKI, P.C, PO BOX 7021, TROY, MI, 48007-7021, US

(73) Assignee: Henry R. Bucciero, Harper Woods, MI (US)

(21) Appl. No.: 11/769,966

(22) Filed: Jun. 28, 2007

Related U.S. Application Data
(60) Provisional application No. 60/819,785, filed on Jul. 10, 2006.

(51) Int. Cl. F16B 37/12

(52) U.S. Cl. 411/438

(57) ABSTRACT

A cylindrical threaded fastener is formed by a spring spirally wound to form a coil of a plurality of turns of spring wire in substantially contiguous relationship to one another and driving means formed by the terminal ends of the spring wire.

### RELATED APPLICATION

This application claims priority of U.S. patent application Ser. No. 11/677,234 filed Feb. 21, 2007; U.S. Patent Application Ser. No. 60/775,236 filed Feb. 21, 2006 and U.S. Patent Application Ser. No. 60/819,785 filed Jul. 10, 2006, all of which are incorporated herein by reference.

### FIELD OF THE INVENTION

This invention relates to cylindrical elongated threaded fasteners such as bolts and nuts and more particularly to such fasteners formed by spirally winding spring of sufficient tensile strength to be self-supporting and forming the ends of the spring wire in such a way as to allow torsional forces to be applied to the resulting elements for fastening them and unfastening them with complementary threaded fasteners.

### BACKGROUND OF THE INVENTION

Threaded fasteners such as nuts and bolts are conventionally formed by machining threads into bar stock or tubular stock, typically with automatic screw making machinery, or alternatively by casting smaller threaded fasteners.

### SUMMARY OF THE INVENTION

The present invention is directed toward cylindrical threaded fasteners such as bolts and nuts, which are formed by spirally winding high tensile spring wire to form the elements. The threaded fasteners of the present invention will typically be lighter in weight and lower in cost than similar threaded fasteners fabricated from solid material. Additionally, they will have vibration resistance and a virtual self-locking feature because of their resiliency in the axial direction of the resulting threaded fastener. Fasteners of the present invention are preferably formed using computer controlled spring winding machines which allow control over the pitch and the diameter of the fastener along its length.

The spring wires used to fabricate threaded fasteners formed in accordance with the present invention are those wires having a tensile strength in excess of above 100,000 psi. These wires are commercially available as hard drawn and alloyed steels, stainless steel, titanium and other alloys including aluminum alloys and plastic materials in certain applications. The fasteners formed in accordance with the present invention have the ends of the wires used to form the elements bent in such a way as to allow the application of torsion to insert and remove the fasteners. With a screw, the end is typically bent so as to allow use of conventional screwdrivers and the nuts formed in accordance with the present invention typically have extending end wires which allow the application of torque through use of special drivers to insert and remove the fasteners.

By forming the threaded fasteners of the present invention with a slightly different pitch than that associated with their complementary fasteners, the inherent elasticity of the spring in the axial direction will create self-locking forces.

The screws and bolts formed in accordance with the present invention typically have a relatively long cylindrical coiled section of a first diameter with a relatively short enlarged coiled section of a greater diameter formed at one end to act as a head for the fastener.

### BRIEF DESCRIPTION OF THE DRAWINGS

Other objects, advantages and applications of the present invention will be made apparent by the following detailed description of several preferred embodiments of the invention. The description makes reference to the accompanying drawings in which:

FIG. 1 is a perspective view of a screw or bolt formed in accordance with the present invention;

FIG. 2 is an end view of the screw or bolt of FIG. 1;

FIG. 3 is a perspective view of a nut formed in accordance with the present invention;

FIG. 4 is a perspective view of a nut formed in accordance with FIG. 3 threadingly engaged with a bolt formed in accordance with FIG. 1;

FIG. 5 is a perspective illustration of an assembly used by joining a nut formed in accordance with the present invention with a bolt formed in accordance with the present invention through use of a specialized driver adapted to engage and rotate the nut; and

FIG. 6 is a cross-sectional view of the assembly of FIG. 4 taken along line 6-6 of FIG. 4.

### DETAILED DESCRIPTION OF THE INVENTION

The threaded fasteners of the present invention have bodies formed by spirally winding spring wire into a cylindrical configuration. The spring wire employed in these devices must have a sufficient tensile strength to be self-supporting in application. Any of the common spring wire materials listed in Table 1 on pages 41-48 of the Handbook of Spring Design published by the Spring Manufacturers Institute, Rolling Meadows, Ill., 1953 publication, may be used in accordance with the present invention. In general, these wires have a tensile strength in excess of 100,000 psi.

The fasteners of the present invention are designed to be formable by using commercially available computer controlled spring winding machines but could be formed in special machines or even manually.

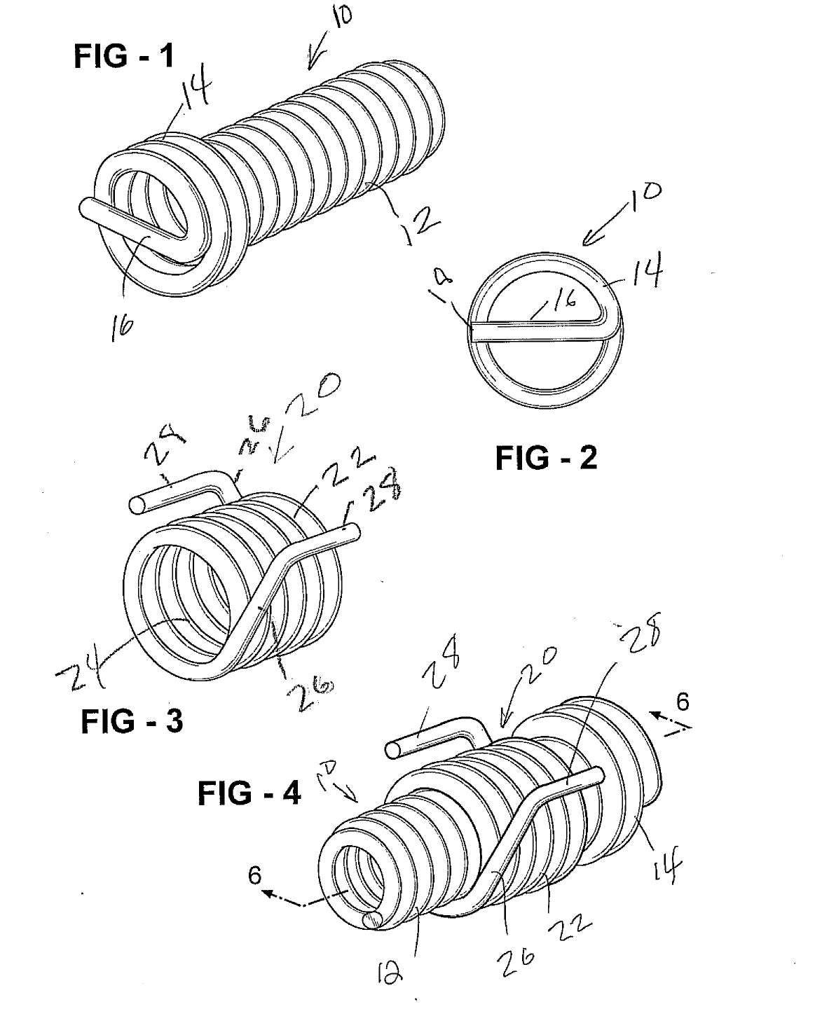

FIGS. 1 and 2 illustrate a bolt 10 formed in accordance with the present invention. The bolt includes a spirally wound cylindrical body 12 in which adjacent coils are contacting or closely spaced from one another so that the outer surface forms a spirally wound threaded surface. A head 14 is formed at one end of the body 12 by several turns of the same spring wire, which is an extension of the wire used to form the body 12. In the preferred embodiment, approximately three turns are used to form the head. The head is of increased diameter relative to the body 12. It terminates in a half turn 16 which is bent to extend substantially diametrically across the far end of the head and terminate in an end 18 which is within the perimeter of the coils 14.

The section 16 may be used to tighten or loosen the bolt 10 through an appropriate driver.

A nut formed in accordance with the present invention is generally indicated at 20. The nut consists of a body 22 formed by a plurality of circular turns of spring wire of equal diameter. The turns may be in direct contact with one another or may be slightly separated from one another. The interior surface 24 of the nut forms a threaded surface which is adapted to engage a bolt, either of the construction of the type generally indicated at 10 or a conventional bolt having a pitch diameter close to the pitch of the turns 22. The elasticity of the wound spring in the diametric direction will accommodate variations between the pitches of the present fasteners and their mating elements and provide resistance to movement under vibratory forces and a self-locking capability.

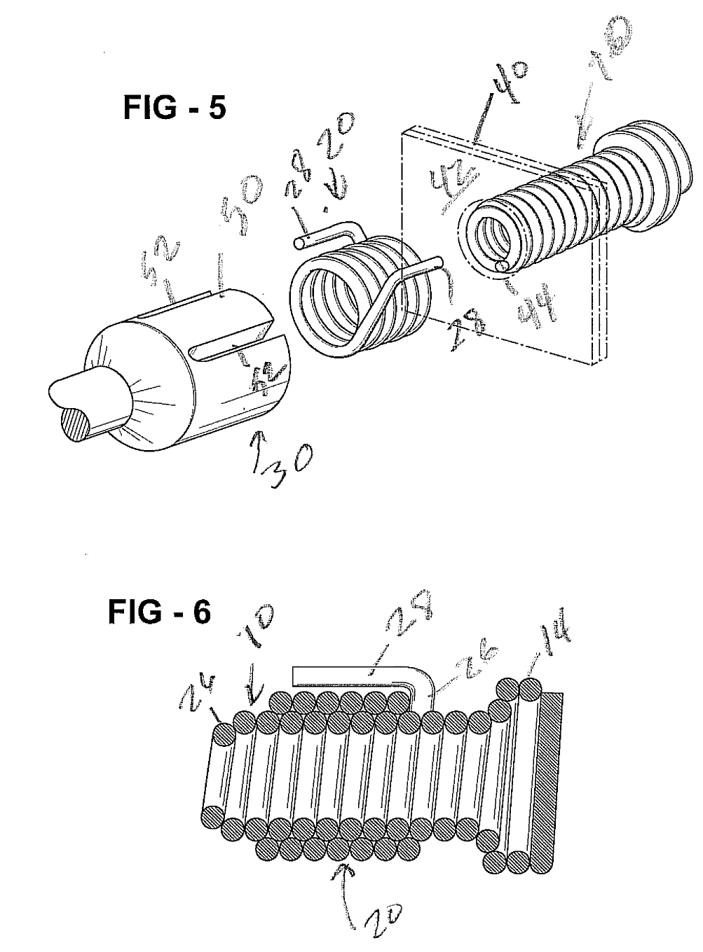

The terminations at each end of the nut 22 extend peripherally outward as at 26 and then are bent parallel to and spaced from the outer surface of the nut 22 and terminate in a section 28. These terminating sections from the opposed ends of the nut face in opposite directions. They enable the nut to be tightened or loosened through use of a driver of the type generally indicated at 30 in FIG. 5, as will be described in connection with FIG. 5.

FIG. 4 illustrates an assembly of the nut of the type generally indicated at 20 threaded over a bolt of the type generally indicated at 10. Both the bolt 10 and the nut 20 are formed of spring wire of the same or closely related diameter resulting in substantially the same pitch to their threads. Thus the interior threads 24 forming part of the bolt threadingly engage the outer surface 12 of the nut. Either the nut or the bolt could be similarly assembled with conventional complementary threaded fasteners formed in a conventional manner, as for example on automatic thread forming machines.

FIG. 6 is a cross section through the assembly of the bolt 10 and nut 20 as illustrated in FIG. 4. This illustration shows how the ultimate threaded turn of the section 10 of the bolt, illustrated at 32, is of slightly smaller diameter than the subsequent turns to allow easy insertion of the bolt into a screw.

FIG. 5 illustrates a bolt, again generally illustrated 10, and a nut, illustrated at 20, in position to lock together two sheets of planar material 40 and 42 with a central hole 44 between them. The hole has a diameter greater than the outer diameter of the bolt but less than the outer diameter of the nut 20 so as to capture the two sections 40 and 42 between the nut and the bolt. The driver 30 is of the type adapted to be attached to a ratchet wrench or the like to rotate the nut onto the bolt. It includes an open end cylindrical body 50 having a pair of longitudinal slots which are adapted to engage the two sections 28 at the terminal ends of the spring which forms the nut 20. Thus, the rotational force may be imparted to the nut 20 to threadingly engage it with the bolt 10 or to remove it from the bolt.

Having thus described my invention I claim:

1. A threaded fastener comprising a coil formed of a plurality of turns of spirally wound spring wire having a tensile strength in excess of 100,000 psi, with the turns substantially abutting one another so as to form a threaded surface; and the wire at least one end of the coil being bent out of the plane of the spiral coil so as to provide a driving surface for imparting rotational motion to the fastener to join and unjoin it from a complementary fastener.

2. The threaded fastener of claim 1 wherein the fastener constitutes a bolt and comprises several contiguous turns of the spring wire at one end of the threaded section of a greater diameter than the threaded section to constitute a head.

3. The threaded fastener of claim 1 forming a nut with the terminal ends of the spring wire at each end of the spiral coil being bent outwardly beyond the outer diameter of the coil and then in the direction of the coil, to provide driving ends for imparting rotational energy to the nut for the purpose of joining it to a complementary threaded fastener.

4. The spiral threaded fastener of claim 1 wherein the spiral turns in the threaded surface of the fastener are abutting one another.

5. The spiral threaded fastener of claim 1 wherein the spirally wound turns are closely spaced from one another.

6. The spiral threaded fastener of claim 2 wherein the terminal section of spring wire at the head end of the fastener is bent across the fastener as a diagonal.

7. The spiral threaded fastener of claim 1 which is formed by a computer controlled spring winding machine.

8. A cylindrical threaded fastener comprising a coil formed of a plurality of turns of spirally wound spring wire having a tensile strength in excess of 100,000 psi, with the turns substantially abutting one another to form a cylindrical body having threads formed on its opposed surfaces.

9. The cylindrical threaded fastener of claim 8 adapted to be employed with a complementary threaded fastener having a slightly different pitch diameter than the coil of said cylindrical threaded fastener.
